(19) United States
(12) Patent Application Publication
(10) Pub. No.: US 2025/0206581 A1
(43) Pub. Date: Jun. 26, 2025

(54) TIP-OVER PREVENTION SYSTEM, BOOM OF AN OFFSHORE CRANE, OFFSHORE CRANE

(71) Applicant: GustoMSC B.V., Schiedam (NL)

(72) Inventors: Eelco Harry KROL, Den Hoorn (NL); Michiel Giovanni MOL, Rotterdam (NL)

(21) Appl. No.: 18/852,002

(22) PCT Filed: Mar. 31, 2023
(86) PCT No.: PCT/NL2023/050172

§ 371 Date: Sep. 27, 2024

(30) Foreign Application Priority Data
Mar. 31, 2022 (NL) 2031470

(51) Int. Cl. B66C 23/88; B66C 23/52

(52) U.S. Cl. CPC B66C 23/88; B66C 23/52

(57) ABSTRACT

Tip-over prevention system (8) for an offshore crane, comprising a boom mounted part (9) that is arranged to be mounted to a boom (3) of the offshore crane (1); a support mounted part (10) to be mounted to a support structure (2) for the offshore crane; wherein the boom mounted part comprises a frame with at least one longitudinally extending chord (16); wherein the support mounted part comprises a biasing element (14) that is biased towards an extended position, wherein the boom mounted part and the support mounted part are configured to engage with each other when a boom angle (a) of the boom exceeds a predefined threshold.

The invention relates to an offshore crane. In particular, the invention relates to a tip-over prevention system for an offshore crane.

Offshore cranes are widely known, and are typically mounted on a floating structure, such as a vessel or a barge or a jack-up. Offshore cranes can be used for various purposes, for example for heavy lifting operations at an offshore location such as installation and decommissioning of heavy structures like wind turbines, wind turbine foundations, platforms, top sides of platforms, etc.

An offshore crane typically comprises a boom pivotally mounted to a support structure. At a boom tip, a load can be hoisted. Various failure modes are known to crane designers, and the design and construction of an offshore crane is done taking into account such failure modes. One such failure may be known as boom tip-over. A swinging motion of the boom, induced by one or the other force or sudden absence of force, caused by a calamity e.g. a loss of load, or a failure of a luffing or hoisting wire, vessel motions, a lifting hook failure, may cause tipping over the boom, i.e. tilting of the boom backwards past the vertical. This results in structural damage or total loss of the boom and/or of structures near or behind the boom. Various structures are known to limit a position of the boom and/or to define an end position of the boom. The most commonly used structure is a boom stopper: a hydraulic cylinder, typically, mounted on an A-frame or a similar structure, engaging the boom in a direction transverse to the longitudinal direction of the boom. When the boom reaches an end position, the boom stopper engages a stop surface. The efficacy of such boom stoppers is however limited, and may not prevent that the boom tips-over or may not prevent structural damage to the boom.

An aim of the invention is to provide for a tip-over prevention system for an offshore crane. In particular, an aim of the invention is to provide a tip-over prevention system that may efficiently and/or effectively limit or prevent tipping over of the boom.

Thereto, the invention provides for a tip-over prevention system comprising a boom mounted part and a support mounted part. One of the boom mounted part and the support mounted part comprises a frame with at least one longitudinally extending chord, the other one of the boom mounted part and the support mounted part comprises a biasing element that is biased towards an extended position. The boom mounted part may comprise the frame with the at least one longitudinally extending chord, wherein a distance of the at least one chord to the boom is larger near a frame base and is smaller near a frame tip. The at least one longitudinally extending chord may then include an angle with a longitudinal main axis of the boom, wherein said angle may be in the range of 1 to 30 degrees, more preferably in the range of 5 to 25 degrees, even more preferably in the range of 10 to 20 degrees, for example about 15 degrees. It has been found that such an angle can yield a particularly favorable combination of transverse and longitudinal tip-over prevention action on the boom, wherein the transverse component can be associated with a more immediate countering of an adverse swinging motion while the longitudinal component can be associated with loading of the boom along its longitudinal axis. Without wishing to be bound by theory, it is believed that such an angle may thus advantageously convert at least part of a momentum associated with a swinging of the boom to a loading of the boom along its longitudinal axis.

The frame may be embodied as a truss frame or non-truss frame such as a box shaped frame or a frame comprising plates and/or trusses. As such, the frame with the at least one chord, can be, in a side view, triangular shaped with respect to the boom, with the chord extending obliquely towards the boom. A frame base of the frame can be at a bottom end of the boom, the boom base. At the boom base, the distance between the at least one chord and the boom may be larger than further away from the boom base, with the chord being directed towards the boom. The at least one chord of the frame can be connected to the boom by means of braces or trusses, at least at a bottom end of the chord and/or at a top end of the chord. The at least one chord of the frame can be directly connected to the boom, or can be connected to the boom via braces. In the latter case, the at least one chord can be said to be floating, or can be said to be supported by the braces only to the boom. Preferably, the frame comprising the at least one chord is mounted to the boom, and is permanently connected to the boom, also during normal operations. The trusses or braces of the frame can connect to trusses or braces of the boom, and/or can connect to chords of the boom. In known designs, booms comprise, and may even mainly consist of, such trusses, braces and/or chords. Nevertheless, it shall be appreciated that a boom may be designed partly or fully without such elements, e.g. comprising one or more beams, plates, etc. Over a length of the frame, multiple trusses or braces can be provided that can connect to the boom at various longitudinal and/or radial positions of the boom. As such, over a length of the boom where the boom mounted part is connected to the boom, connections between trusses of the frame of the boom mounted part on the one hand and trusses or chords of the boom on the other hand, are provided at multiple distinguished positions in axial direction, i.e. a longitudinal direction of the boom, and/or in radial direction, i.e. transverse to the axial direction. Such multiple and/or different connections at different positions may provide for a beneficial load transfer from the tip-over prevention system to the boom in case of a calamity. The boom mounted part embodied as a frame, may typically be connected to the boom by welding and/or bolting, but a hinged connection may also be considered.

One of the boom mounted part and of the support mounted part may be hingedly mounted to its associated mounting base, to allow the following of the movement of the boom when the boom mounted part and the support mounted part are engaged. Also, one of the boom mounted part and of the support mounted part is a compressible element, preferably biased towards an extended position, to allow following of the movement of the boom when the boom mounted part and the support mounted part are engaged and/or to absorb energy in case of a calamity.

The boom is at the boom base pivotally connected to a support structure or a base structure. Such support structure or base structure can e.g. be a slewing platform. The support mounted part of the tip-over prevention system is mounted to such support structure. The support mounted part may comprise the biasing element that is biased towards the extended position. The biasing element typically can be a compressible element, in that it can be compressed when contacted and/or loaded. The biasing element can e.g. be a hydraulic cylinder, or a pneumatic cylinder, or a spring-based system. The biasing element may at its lower end be pivotally mounted to the support structure and may at its outer, free end, be configured to engage with the frame of the boom mounted part. The bottom end of the at least one chord of the frame is then preferably configured to engage with the outer end of the biasing element, when an angle of the boom with respect to the horizontal becomes too large, i.e. larger than a safety threshold which may be predefined. The angle of the boom with respect to the horizontal is typically referred to as boom angle. An engagement between the frame and the biasing element is envisaged at or about a boom angle of about 60 degrees, preferably at a boom angle between about 40-70 degrees. When the boom angle then becomes larger, the biasing element is being compressed against the biasing force by the frame. In case of an unintended swinging motion in which the boom angle becomes larger, in particular becomes rapidly larger, the biasing element can absorb energy of the motion, e.g. of the swinging motion, while forces of e.g. an overturning moment can be transferred via the frame to the chords of the boom. As such, forces can be led into a direction in which they do not amplify the swinging motion of the boom, but instead are led to the chords of the boom that are designed to receive such high loads. Thus, the tip-over prevention system can then effectively prevent tip-over of the boom, and may also prevent damage of the boom due to a swinging motion. Also, by providing a truss-frame, a relatively light-weight structure can be provided that effectively can guide loads to the chords of the boom in case of potential tip-over of the boom, thereby limiting or preventing failure.

The boom mounted part and/or the support mounted part advantageously are provided with engagement elements that engage with each other when a boom angle exceeds a predefined angle.

Multiple biasing elements may be provided that engage with the frame of the boom mounted part. For example, it can be considered that two biasing elements share a common engagement element, and as such, can be said to be positioned in parallel. Alternatively, the biasing elements may be positioned in series. Also, a combination of a series and parallel configuration of multiple biasing elements is possible.

Further, it can be understood that the compressible element as biasing element may additionally comprise a damping element, such as a gas buffer or a crumple zone.

Alternatively, the support mounted part may be the fixed element, such as a frame, and the boom mounted part may be the compressible element such as a biasing element. Also then, engagement occurs when the boom angle exceeds a certain threshold, and the boom mounted part is compressed while loads can be directed to the support and/or the boom.

Alternatively and/or additionally, in case of a calamity, when the boom may start accelerating, the biasing element may be locked to stop further movement of the boom, and thus, to prevent further acceleration of the boom. Locking of the biasing element can be done in any position between the fully extended position and the fully compressed position, including those positions. Locking of the biasing element can be obtained passively, e.g. when pressure in the biasing element increases too rapidly. Locking can be done mechanically, hydromechanically or hydraulically, or by other means e.g. to hold the biasing element, or to close off outflow of fluid. Then, in the then extended position, the biasing element can be locked, i.e. the then extended position of the biasing element is frozen and the biasing element is blocked in that position. Parts of the biasing element that are extendable with respect to each other between the fully extended position and the fully compressed position of the biasing element may be, in the locked position, blocked from moving with respect to each other. Locking of the biasing element can be done when the boom mounted part and the support mounted part are engaged such that pressure build-up in the biasing element can be possible, If the pressure on the biasing element becomes too large, e.g. larger than a predefined threshold, the biasing element can be locked; when the pressure may become lower or may drop below a predefined threshold, the locking can be released such that the biasing element can remain engaged with the boom mounted support. Such thresholds for locking and releasing may be the same, but are preferably different so as to prevent too rapid switching between locking and releasing. In other words, a hysteresis effect may thus be provided regarding the locking and releasing.

During normal crane operations, the support mounted part and the boom mounted part engage when a boom angle becomes larger than a predefined boom angle. During normal crane operations, when the support mounted part and the boom mounted part are engaged, the support mounted part and the boom mounted part move together with the movements of the boom. The moving together of the support mounted part and the engaged boom mounted part with the boom in normal operations is smoothly. In normal operations, then the biasing element of the support mounted part is being compressed, and/or expands, to follow the movements of the boom. In normal operations, no or barely any additional loads are induced and/or transferred to the boom by the tip-over prevention system. In case of a calamity however, the boom tip may accelerate and engagement between the boom mounted part and the support mounted part happens when the boom angle exceeds a predefined boom angle, in case they were not engaged yet. Also then, the engaged boom mounted part and support mounted part move together, while additionally energy of the acceleration of the boom tip can be absorbed by the biasing element and/or the biasing element can be locked. Thereby load can be brought into a longitudinal direction of the boom and/or into the support structure. The boom is capable of handling large loads via the chords. As such, a boom tip-over can effectively be prevented without or with limited damage to the boom and/or its environment.

Since the biasing element is biased towards its extended position, when the boom mounted part and the support mounted part are engaged, this may aid in keeping tension on the luffing wires of the luffing system, although slack wire may not be prevented.

In any event, when at about a boom angle of approximately 60 degrees, the bottom end of the at least one chord engages with its associated biasing element, the biasing element may follow the tilting of the boom. In normal operations a boom angle of approximately 83 degrees can be reached. The biasing element may then be in a fully retracted position, in other words, the biasing element may then be fully compressed. When lowering the boom, the biasing element may follow the motion of the boom as well, and when the boom angle becomes lower than approximately 60 degrees, the biasing element and the frame may disengage, and the biasing element is in its extended position again.

Often, an A-frame may be mounted to the support structure, e.g. to guide a luffing system and/or a hoisting system of the crane. Such A-frame has typically four connections with the support structure, arranged as two pairs of connections at a distance from each other. When the boom has at is lower end two boom legs, boom base connections can be integrated to one such pair of A-frame connections or the boom base can have its own support connections separate from the A-frame connections. In the latter example, the boom base connections are usually mounted outwardly of the A-frame connections. Also when the boom is a single boom having a single boom leg, the boom base connection to the support structure can be separate from an A-frame or similar frame structure connection. Advantageously, the biasing element is mounted on the support structure aside of the A-frame as well.

The boom mounted part of the tip-over prevention system is mounted to the boom at an upper side of the boom, which side may also be called a rear side of the boom, i.e. a side of the boom opposite to where a load hoisted by the boom is normally positioned. In a side view, it can be seen that the boom has an additional triangular frame mounted on such an upper side of the boom, in particular near base of the boom. Of course, the frame may be a three-dimensional structure having more of a prismatic shape with a larger bottom at a frame base and boom base, and a smaller tip where the at least one chord of the frame meets or almost meets the chord or the chords of the boom. When a lower end of the boom is configured as two boom legs, each boom leg may be provided with such a frame of the boom mounted part. Then, also, two biasing elements are arranged. For each chord of the frame of the boom mounted part an associated biasing element of the support mounted part is envisaged. For example, when the frame on one boom leg has two longitudinally extending chords that are truss-connected to the boom, there can be two chord lower ends that are configured for engagement with two corresponding biasing elements. Alternatively, the two chord lower ends may join to form one engagement element with a corresponding biasing element.

In rest position, the biasing element is not yet engaged, it is preferably positioned such that it can optimally engage with the frame on the boom, when a boom angle reaches approximately 50, preferably about 60 degrees. So, in rest position, the biasing element has an angle with respect to the support platform, such that engagement with the frame at or about a boom angle of 50 to 70 degrees, preferably around 60 degrees is possible. To retain the biasing element in the rest position, a support arm can be provided that keeps the biasing element in the rest position and that also receives the biasing element again when it disengages from the frame. The support arm can be U-shaped to also limit too large sideway motions of the biasing element. In fact, the biasing element is preferably hingedly mounted to the support structure, so a too large side motion of the biasing element may result in failure of the hinge connections, which may be prevented by the support arm, in particular by the U-shape, such as a U-shaped bracket, of the support arm. Advantageously, in rest position, the biasing element is also biased towards its extended position. When engaged, the biasing element may be compressed and/or expanded to follow the movement of the boom. Also, the angular position of the biasing element may differ from the rest position in order to be able to follow the movement of the boom.

The invention further relates to an offshore crane having a boom pivotally mounted to a support structure, wherein the crane is provided with such a tip-over prevention system. The boom based part is mounted to the boom and the support based part is mounted to the support structure, preferably pivotally mounted to the support structure.

In an example, as alluded to elsewhere herein, the at least one chord of the frame mounted to the lower end of the boom has an angle of between about 8-30 degrees with respect to a longitudinal direction of the boom, preferably about 10-20 degrees, preferably about 15 degrees. The frame may be mounted to the lower 10-50% of the boom, for example to the lower 10-40% of the boom, preferably to the lower 12-35% of the boom length. An upper end of the at least one longitudinal frame chord of the boom mounted part may extend up to about 20-40% of the length of the boom, preferably may extend up to about 25%.

More in general, the boom mounted part is advantageously mounted on the lower end of the boom, preferably on the lower 10-50% of the boom chord. As indicated above, the boom mounted part can be a frame, or can be a compressible element, such as a biasing element.

These and other aspects will further be elucidated with reference to the drawing comprising figures of exemplary embodiments. In the drawing shows:

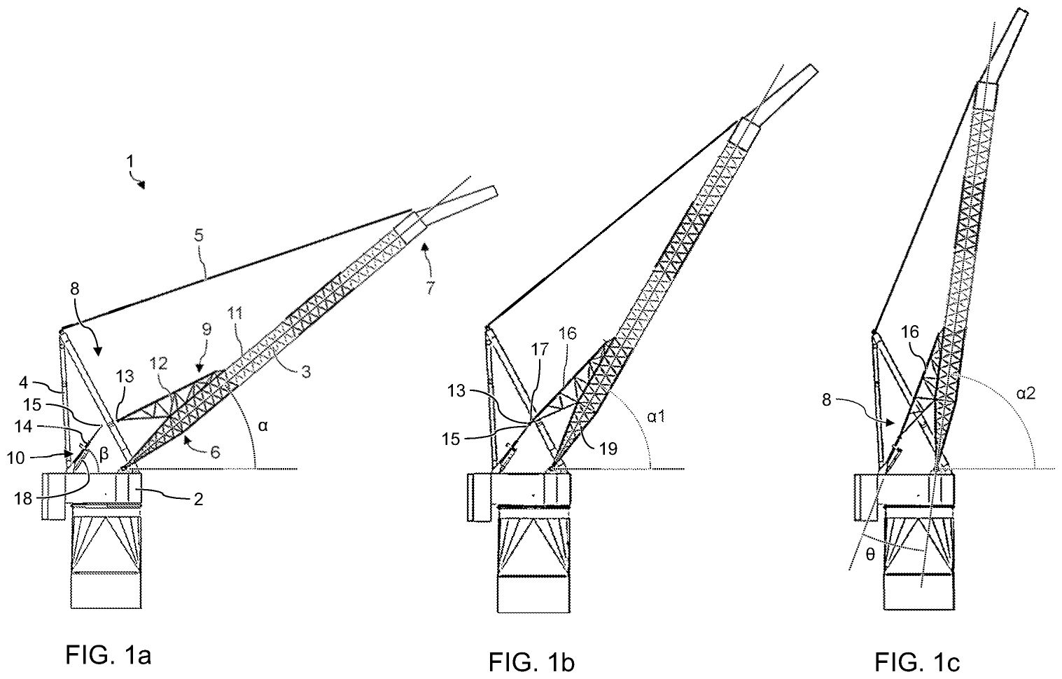

FIG. 1a an offshore crane with a tip-over prevention system in a first position;

FIG. 1b an offshore crane with a tip-over prevention system in a second position;

FIG. 1c an offshore crane with a tip-over prevention system in a third position;

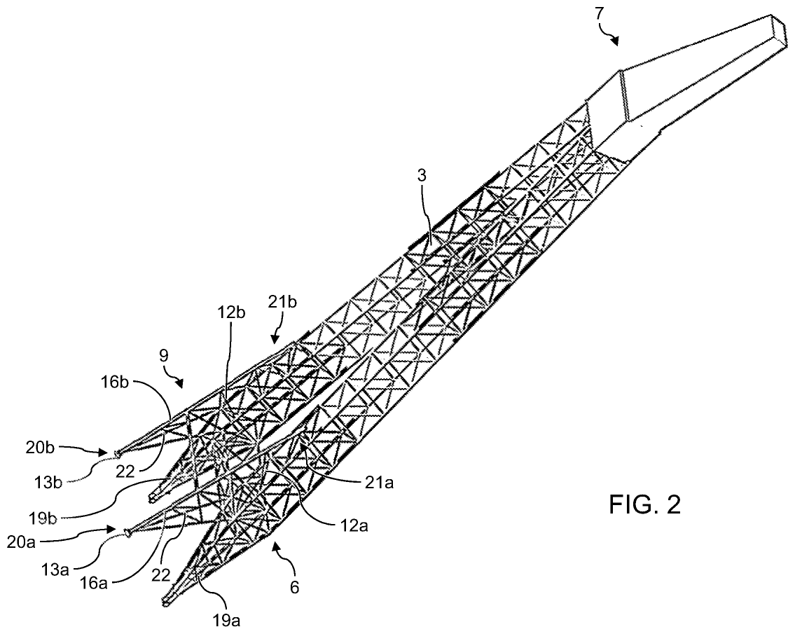

FIG. 2 a boom of an offshore crane with the boom mounted part of the tip-over prevention system;

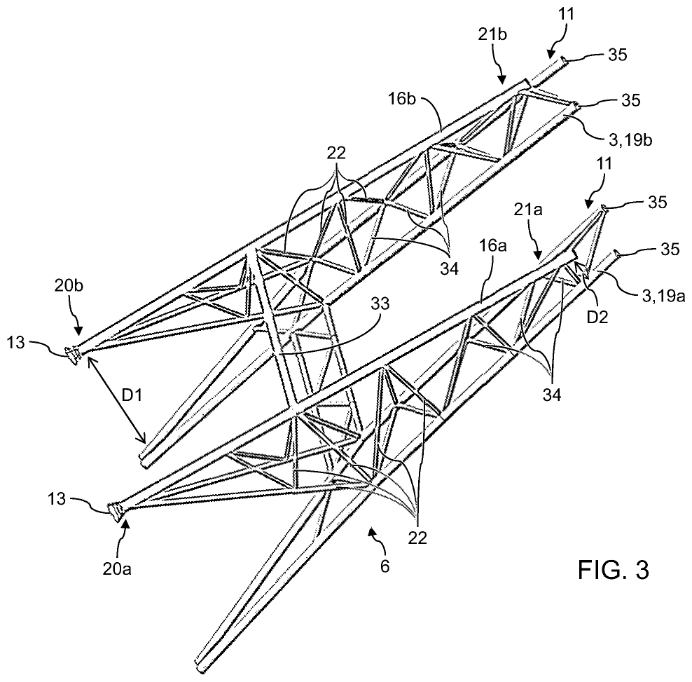

FIG. 3 a detail of the boom mounted part of FIG. 2;

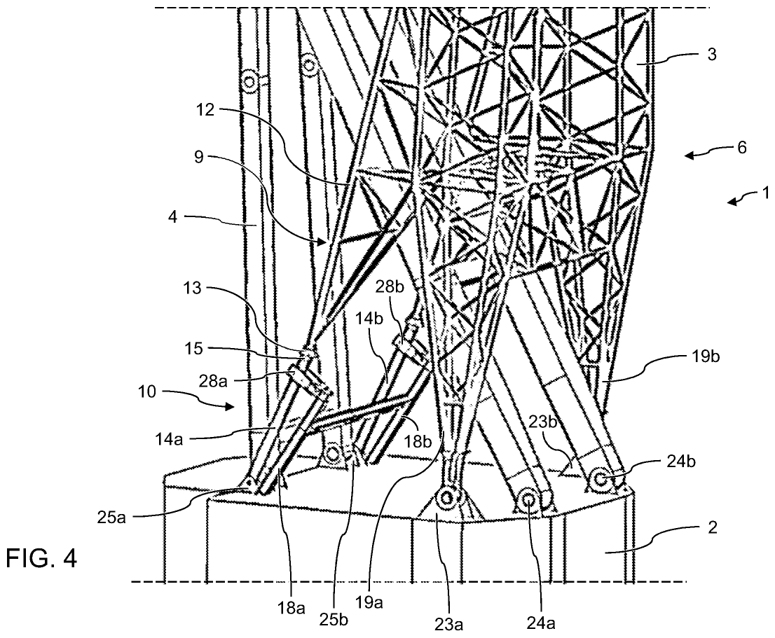

FIG. 4 a detail of the support mounted part with support arm in a context corresponding to that of FIG. 1C;

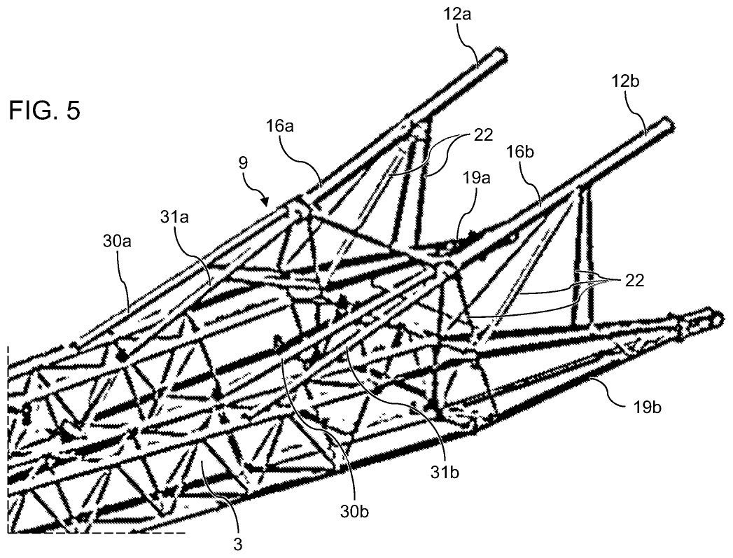

FIG. 5 an alternative embodiment of the boom mounted part of the tip-over prevention system.

It is to be noted that the figures are given by way of examples and are not limiting to the disclosure. The drawings may not be to scale. Corresponding elements are designated with corresponding reference signs.

FIG. 1a shows an offshore crane 1 mounted onto a support structure or base structure 2. The offshore crane 1 comprises a boom 3 pivotally mounted to the support structure 2, and an A-frame 4 comprising for example a luffing system and/or a hoisting system 5. Here, a pair of connections of the A-frame 4 is positioned in between pivot connections of the boom to the support structure 2, but it is understood that they can coincide as well. The boom 3 has a boom base 6 and a boom tip 7. At the boom tip 7 a load can be hoisted. The offshore crane 1 is provided with a tip-over prevention system 8 comprising a boom mounted part 9 and a support mounted part 10. The boom mounted part 9 is here in side-view seen as a triangular truss-frame 12 connected to an upper or rear side 11 of the boom. At a lower end or a base end of the truss-frame, an engagement element 13 is provided that is configured to engage with the support mounted part 10. The support mounted part 10 is here provided as a biasing element 14 such as e.g. a hydraulic or pneumatic cylinder. The biasing element 14 is pivotally mounted to the support structure 2 and extends in a longitudinal direction. At an outer end of the biasing element an engagement element 15 is provided that is configured to engage with the engagement element 13 of the boom mounted part 9. Both boom mounted part 9 and support mounted part 10 cooperate together to prevent or limit tip-over of the boom 3, in case of a calamity causing excessive loads and/or motions.

In FIG. 1a the boom 3 is shown in a first position, in which the boom mounted part 9 is free from the support mounted part 10 and the boom mounted part 9 is not engaged with the support mounted part 10. Typically, this applies to boom angles up to about 50 to 70 degrees, e.g. to boom angles up to about 50 to 60 degrees. The boom angle alpha is considered to be the angle between a longitudinal axis of the boom and a horizontal, as schematically indicated in FIG. 1a. The support based part 10, in particular a biasing element 12 of the support based part 10 is biased towards an extended position.

In FIG. 1b is shown that, when the boom angle reaches a predefined angle alpha1, which can be set to between about 50 degrees to 70 degrees or any value in between or about such angle, e.g. to about 60 degrees, the boom mounted part 9 engages with the support mounted part 10. To that end, the boom mounted part 9 can be provided with a boom based engagement element 13, and the support mounted part 10 can be provided with a support based engagement element 15. Then, the boom based engagement element 13 engages with its associated support based engagement element 15. For example, when the boom mounted part 9 has one chord 16 to which lower end 17 the boom engagement element 13 is provided, then this boom based engagement element 13 has a corresponding and associated support based engagement element 15 on the associated biasing element 14. In another example, the frame 12 may have two longitudinally extending chords 16 each having at their lower ends 17 a boom based engagement element 13, then two associated support based engagement elements 15 are provided which can be connected to two separate biasing elements or which can be connected to a same single biasing element. Multiple biasing elements can be arranged in a series configuration or in a parallel configuration or in a combination thereof. Upon engagement of the boom mounted part 9 with the support mounted part 10, the biasing element 14 is being compressed against the biasing force. As such, the biasing element 14 can follow the movement of the crane boom 3, until a position in which the biasing element 14 is fully compressed and the boom 3 is in its most upward position, as shown in FIG. 1c. The boom angle alpha 2 can be then as large as 83 degrees or even 85 degrees. In case of a calamity causing unintended boom motions and/or boom accelerations, the tip-over prevention system 8 may absorb energy resulting from such motions as well as may guide excess loads towards the chords of the boom 3, and/or towards the support structure 2. Thus, tip-over of the boom 3 may be limited or may be prevented.

As can be seen in the FIGS. 1a, b, c, and in more detail in FIG. 4, the biasing element 14 is supported by a support arm 18. The support arm 18 holds the biasing element 14 in its neutral position, as shown in FIG. 1a, in which it is ready to engage the boom mounted part 9. To optimally engage the boom mounted part 9, when the boom 3 reaches the boom angle alpha1, the biasing element 14 preferably is positioned under an angle beta, being between about 30 degrees and about 65 degrees, depending on, e.g. similar to, the angle alpha1 in which engagement is envisaged. Once the biasing element 14 is engaged with the frame 12, the biasing element 14 can rotate together with the rotation of the boom 3, and can come free from the support arm 18, at least regarding such a rotation. The support arm 18 can be provided, at its outer end with a U-shaped bracket to also limit transversal movements of the biasing element 14. In this sense, the support arm 18 may continue to cooperate with the biasing element 14 throughout various rotational positions of the biasing element 14.

FIG. 2 shows an example of a boom 3 of an offshore crane. Here, the boom 3 comprises at its boom base 6 two boom legs 19a, 19b. Each boom leg 19a, 19b is hingedly mounted to the support structure allowing pivoting movement of the boom 3 around a rotation axis of the hinges only. The frames 12a, 12b are mounted to an upper or rear side 11 of the boom 3.

The boom mounted part 9 here comprises two frames 12a, 12b connected to the two legs 19a, 19b, in particular each to a respective leg. So, there is per leg 19a, 19b an additional frame 12a, 12b provided. Each frame 12a, 12b comprises a chord 16a, 16b respectively. The chords 16a, 16b are longitudinally extending and are arranged in an oblique orientation with respect to the boom 3, in particular with respect to a boom longitudinal axis. Here, an angle theta (see FIG. 1c) between a chord 16 and said longitudinal axis is about 15 degrees. At a lower end 20a, 20b of the chord 16a, 16b the distance between the chord 16 and the boom 3 is larger than the distance between the chord 16 and the boom 3 at an upper end 21a, 21b of the chord. The chords 16a, 16b are connected to the boom 3 via trusses or braces 22. In the detail of FIG. 3 it can be seen that the upper ends 21a, 21b of the chords 16a, 16b are floating and do not themselves connect with the boom, but are connected to the boom via trusses 22. This ensures a more smooth force transition. At the lower end 20a, 20b, the chords 16a, 16b are connected to the boom 3 via trusses 22. There, the trusses 22 connect to a position on the boom legs 19a, 19b. The boom based engagement elements 13 that are provided at the lower ends 20a, 20b of the chords 16a, 16b are seen in FIG. 3 as being embodied as trumpet-shaped elements. It is understood that other shapes of the engagement elements are possible as well. In this embodiment, the two frames 12a, 12b are interconnected to each other with an additional brace 33, but this is optional. The brace 33 can also be omitted. The longitudinally extending frame chords 16a, 16b are connected to the boom 3, in particular to the boom base 6 via multiple trusses 22. The multiple trusses 22 can connect to trusses 34 of the boom 3, or can connect to chords 35 of the boom 3. By connecting the longitudinally extending chords 16a, 16b at multiple distinct positions to the boom 3, the load can be transferred to the boom 3 in a distributed manner, allowing a relatively large load to be transferred before damage may occur. This allows for a relatively high load transfer of the forces that may occur when a boom tip may swing and/or accelerate due to a calamity or otherwise. Also, the chords 16a, 16b are at a lower end 20a, 20b respectively at a larger distance D1 from the boom 3, in particular from an upper side 11 of the boom 3 than a distance D2 at their upper end 21a, 21b. In examples where the frame chord 16 directly connects with the boom 3, e.g. with a boom chord 35, the distance D2 even becomes zero. As such, the at least one frame chord is obliquely directed towards the boom 3, thereby directing forces to be transmitted to the boom 3 or to the boom chords 35 in an effective manner.

It is noted that a frame 12 can be provided with two chords instead of a single chord, which two chords may reach towards two upper chords of a boom 3 or of a boom leg 19.

FIG. 4 shows the boom base 6 hingedly mounted to the support structure 2 via boom connections 23a, 23b of the boom legs 19a, 19b respectively. Here, the boom connections 23a, 23b are separate from A-frame connections 24a, 24b. The boom mounted structure 9 is here shown as engaged with the support mounted part 10, the respective engagement elements 13, 15 cooperating with each other. In this position of the boom 3, the biasing elements 14 of the support mounted part 10 are almost completely compressed, indicating that the boom 3 is in its upper position or is almost in its upper position having a boom angle of about 83 or 85 degrees. The biasing elements 14a, 14b engaging the frames 12a, 12b of the boom mounted structure 9 respectively, are hingedly connected to the support structure 2 via connections 25a, 25b respectively. As explained above, each biasing element 14a, 14b of the support mounted part 10 is supported by a support arm 18a, 18b. The U-shaped ends 28a, 28b of the support arms 18a, 18b support the biasing element 14a, 14b respectively in neutral position, when there is no engagement yet with the boom mounted part 9. Also, the U-shaped ends 28a, 28b limit sideway motions of the biasing elements 14a, 14b, which may secure the integrity of the hinge connections 25a, 25b. Here, with the boom 3 in an upward position, i.e. at a large boom angle, it can be seen that the biasing elements 14a, 14b are at a distance from a bottom of the U-shaped support ends 28a, 28b, but are still in between arms of the U-shaped support ends 28a, 28b. In this example, the support arms 18a, 18b are interconnected with each other with a bar 29, but this is optional.

FIG. 5 shows an alternative embodiment of the boom mounted part 9. The boom mounted part 9 is connected to the boom 3, in particular to the boom base 6. The boom base 6 here has two boom legs 19a, 19b. The boom mounted part 9 comprises at least one frame 12, here two frames 12a, 12b are provided for each leg 19a, 19b respectively. Each frame has at least one longitudinally extending chord 16a, 16b that at its lower end is at a distance from the boom 3 and extends in a direction towards the boom 3. Here the longitudinally extending frame chord 16a, 16b splits into two chords 30a, 31a, 30b, 31b that directly connect to the respective boom chords of the boom legs 19a, 19b. In this embodiment the frame 12a, 12b comprises multiple trusses 22 that connect at multiple distinct positions to the boom chords. As such, forces can be transferred to the boom 3 in a distributed manner.

In an alternative embodiment, the boom mounted part 12 may be the compressible element that advantageously is biased towards an extended position. The support mounted part 10 may then be a frame, or a frame like structure. Such frame like structure may be hingedly mounted to the support structure 2 to allow the boom mounted part and the support mounted part to follow movement of the boom once engaged. Alternatively, the boom mounted part is hingedly mounted to boom such that, when engaged with the support mounted part, the movement of the boom can be followed.

Tip-over prevention system for an offshore crane, comprising a boom mounted part that is arranged to be mounted to a boom of the offshore crane; a support mounted part to be mounted to a support structure for the offshore crane; wherein the boom mounted part comprises a frame with at least one longitudinally extending chord; wherein the support mounted part comprises a biasing element that is biased towards an extended position, wherein the boom mounted part and the support mounted part are configured to engage with each other when a boom angle of the boom exceeds a predefined threshold.

For the purpose of clarity and a concise description, features are described herein as part of the same or separate embodiments, however, it will be appreciated that the scope of the claims and disclosure may include embodiments having combinations of all or some of the features described. It may be understood that the embodiments shown have the same or similar components, apart from where they are described as being different.

In the claims, any reference signs placed between parentheses shall not be construed as limiting the claim. The word ‘comprising’ does not exclude the presence of other features or steps than those listed in a claim. Furthermore, the words ‘a’ and ‘an’ shall not be construed as limited to ‘only one’, but instead are used to mean ‘at least one’, and do not exclude a plurality. The mere fact that certain measures are recited in mutually different claims does not indicate that a combination of these measures cannot be used to an advantage. Many variants will be apparent to the person skilled in the art as long as they are comprised within the scope of the invention defined in the following claims.

1. A tip-over prevention system for an offshore crane, comprising:
a boom mounted part that is arranged to be mounted to a boom of the offshore crane;
a support mounted part to be mounted to a support structure for the offshore crane;
wherein one of the boom mounted part and the support mounted part comprises a frame with at least one longitudinally extending chord;
wherein the other one of the boom mounted part and the support mounted part comprises a biasing element that is biased towards an extended position,
wherein the boom mounted part and the support mounted part are configured to engage with each other when a boom angle of the boom exceeds a predefined boom angle threshold.

2. The system according to claim 1, wherein the boom mounted part comprises the frame with the at least one longitudinally extending chord, wherein the support mounted part comprises the biasing element that is biased towards the extended position.

3. The system according to claim 2, wherein a distance of the at least one chord to the boom is larger near a frame base of the frame and is smaller near a frame tip of the frame.

4. The system according to claim 2, wherein, in a side view, the frame is triangular shaped with respect to the boom, with the at least one chord extending obliquely towards the boom.

5. The system according to claim 2, wherein the frame is permanently connected to the boom.

6. The system according to claim 2, wherein, over a length of the boom where the boom mounted part is connected to the boom, connections between trusses of the frame of the boom mounted part and trusses or chords of the boom are provided at multiple distinguished positions in an axial direction, which is a longitudinal direction of the boom, and/or in a radial direction, which is transverse to the axial direction.

7. The system according to claim 1, wherein the support mounted part is to be mounted to a support structure to which the boom is to be pivotally connected, in particular at a boom base of the boom.

8. The system according to claim 1, wherein the predefined boom angle threshold is in the range of 40 to 70 degrees.

9. The system according to claim 1, configured to automatically lock the biasing element in response to a pressure on the biasing element exceeding a first predefined pressure threshold.

10. The system according to claim 9, configured to automatically release a locked biasing element in response to a predefined release criterion, in particular in response to the pressure on the biasing element falling below a second predefined pressure threshold equal to or smaller than the first predefined pressure threshold.

11. The system according to claim 1, further comprising a support arm configured to retain the biasing element in a rest position in which the biasing element has an angle with respect to the support platform such that engagement with the frame at or about an angle of 50 to 70 degrees is possible.

12. The system according to claim 11, wherein the support arm has a U-shape to limit sideway motions of the biasing element, in particular at the rest position.

13. An offshore crane having a boom pivotally mounted to a support structure, wherein the crane is provided with the tip-over prevention system according to claim 1, wherein the boom mounted part is mounted to the boom and the support mounted part is mounted to the support structure.

14. The offshore crane according to claim 13,
wherein the boom mounted part comprises the frame with the at least one longitudinally extending chord, wherein the support mounted part comprises the biasing element that is biased towards the extended position, and
wherein the at least one longitudinally extending chord of the frame has an angle of between about 1-30 degrees with respect to a longitudinal direction of the boom.

15. The offshore crane according to claim 13,
wherein the boom mounted part comprises the frame with the at least one longitudinally extending chord, wherein the support mounted part comprises the biasing element that is biased towards the extended position, and
wherein the frame is mounted to the boom at the lower 10-50% of the boom length of the boom.

16. The offshore crane according to claim 15, wherein an upper end of the at least one longitudinal frame chord of the boom mounted part extends up to about 10-50% of the boom length.

17. A method comprising using the offshore crane according to claim 13 for lifting operations, in particular heavy lifting operations at an offshore location.

18. The offshore crane according to claim 13, wherein the support mounted part is mounted pivotally to the support structure.

19. The offshore crane according to claim 15,
wherein the frame is mounted to the boom at the lower 12-40% of the boom length.

20. The offshore crane according to claim 16, wherein the upper end of the at least one longitudinal frame chord of the boom mounted part extends up to about 30% of the boom length.
